(19) United States
(12) Patent Application Publication
(10) Pub. No.: US 2005/0192134 A1
(43) Pub. Date: Sep. 1, 2005

(54) Step motor arrangement in belt-type continuously variable transmission

(75) Inventors: Nobufumi Yamane, Tokyo (JP); Yoshihide Shinso, Kanagawa (JP); Haruo Kumada, Yokohama (JP)

Correspondence Address: FOLEY AND LARDNER;SUITE 500, 3000 K STREET NW, WASHINGTON, DC, 20007, US

(73) Assignee: JATCO Ltd

(21) Appl. No.: 11/065,445

(22) Filed: Feb. 25, 2005

(30) Foreign Application Priority Data
Mar. 1, 2004 (JP) 2004-056354

(51) Int. Cl. F16H 55/56; F16H 59/00

(52) U.S. Cl. 474/18; 474/8; 474/28

(57) ABSTRACT

In a belt-type continuously variable transmission having a speed-change mechanism, a step motor arrangement including a pulley follower engaged with a movable sheave of the primary pulley, a speed-change control valve for controlling a primary pressure to be supplied to the primary pulley, a servo link, and a step motor for driving, by way of the servo link, the speed-change control valve in response to a speed-change command signal, the servo link being connected to the pulley follower to follow a variation in a width of a groove of the primary pulley, wherein the pulley follower, the speed-change control valve and the step motor are arranged side by side in the horizontal direction, and wherein the servo link extends generally horizontally from the pulley follower to interconnect the pulley follower, the speed-change control valve and the step motor.

### BACKGROUND OF THE INVENTION

The present invention relates to a belt-type continuously variable transmission having a step motor for controlling an oil pressure to be supplied to a pulley and more specifically to a step motor arrangement in a belt-type continuously variable transmission.

Hereinbefore, it is known that a belt-type continuously variable transmission using a V-belt (hereinafter referred to simply as belt-type CVT) is suited for use in vehicles.

An example of the belt-type CVT is shown in FIG. 3.

The belt-type CVT includes a speed-change mechanism 10 whose principal portion is constituted by a pair of pulleys, i.e., a primary pulley 16 on the input shaft 15 side and a secondary pulley 26 on the output shaft 30 side. The input shaft 15 is connected to an engine by way of a forward and reverse switching mechanism and a torque converter having a lock-up clutch.

The pulleys 16, 26 of the speed-change mechanism 10 are drivingly connected to each other by a V-belt 12.

The primary pulley 16 consists of a fixed sheave 16a rotatable together with the input shaft 15 and a movable sheave 16b axially movable relative to the fixed sheave 16a so as to form therebetween a pulley groove of a variable width.

The secondary pulley 16 consists of a fixed sheave 26a movable together with the output shaft 30 and a movable sheave 26b axially movable relative to the fixed sheave 26a so as to form therebetween a groove of a variable width.

The primary pulley 16 and secondary pulley 26 are provided with a primary cylinder chamber 17 and a secondary cylinder chamber 27 and supplied with a primary pressure (Ppri) and secondary pressure (Psec) from an oil pressure control section 5, respectively.

The oil pressure control section 5 generates a line pressure by regulating an oil pressure from an oil pump OP. Further, the oil pressure control section 5 controls the line pressure in response to a command from a CVT control unit 3 to produce a primary pressure and a secondary pressure.

During running of a vehicle, the widths of the pulley grooves of the primary pulley 16 and secondary pulley 26 are varied depending upon a variation of an oil pressure supplied to the respective cylinder chambers 17, 27, thus varying the winding diameters of the belt 12 wound around the pulleys 16, 26 thereby varying the transmission ratio between the primary pulley 16 and the secondary pulley 26 continuously.

FIG. 4 shows a primary pressure supply circuit structure in the oil pressure control section 5 for supplying a primary pressure to the primary pulley cylinder chamber 17. The oil pressure control section 5 includes a speed-change control valve 35 for controlling the primary pressure through control of the line pressure. Herein, the line pressure serves as the second pressure and is supplied to the secondary pressure chamber 27.

The speed-change control valve 35 has a spool 36 connected to an intermediate portion of a servo link 50A that constitutes a mechanical feedback device and is driven by a step motor 40 connected to an end of the servo link 50A. The other end of the servo link 50A is connected to a pulley follower 45A that follows movement of the movable sheave 16b of the primary pulley 16. By this, the shift control valve 35 receives feedback of the width of the primary pulley 16, i.e., the actual transmission ratio.

The transmission ratio between the primary pulley 16 and the secondary pulley 26 is controlled by the step motor 40 that operates in response to a speed-change command signal from the CVT control unit 3.

In the meantime, the line pressure is controlled to a predetermined value in accordance with an engine operating condition, by means of a pressure control valve (not shown) and based on a command (e.g., a duty signal) from the CVT control unit 3.

FIGS. 5 and 6 show the prior art arrangement of the step motor and the servo link.

Right under the primary pulley 16 and within a transmission case 2 is disposed a guide shaft 8 that is positioned between the transmission case 2 and a pulley support block 6. The pulley support block 6 is fixed within the transmission case 2 and in parallel with an axis of rotation of the primary pulley 16. Slidably supported on the guide shaft 8 is a pulley follower 45A.

The pulley follower 45A has a sleeve portion 46 rotatable on the guide shaft 8 and an engagement portion 47 extending from the sleeve portion 46 toward the primary pulley 16 side. The engagement portion 47, when viewed in the axial direction of the guide shaft 8, is in the form of a circular arc corresponding to the outer periphery of the movable sheave 16b of the primary pulley 16. The engagement portion 47 has a stepped cross section so as to include a first surface 47a in contact with the movable sheave 16b, which first surface is located on the side opposite to the fixed sheave 16a side and a second surface 47b in contact with the outer circumferential periphery of the movable sheave 16b. The pulley follower 45A is always urged against the movable sheave 16b by means of a spring 58 disposed between the transmission case 2 and the pulley follower 45A and slidably movable in accordance with a variation of the axial position of the movable sheave 16b.

The sleeve portion 46 of the pulley follower 45A is further provided with a connecting pin 48A for connection with an end of the servo link 50A which will be described later.

The valve body 60A is provided with the shift control valve 35 which is disposed under the guide shaft 8 and which includes a valve spool 36 slidable in a valve bore 64 in parallel with the guide shaft 8.

To the lower surface of the valve body 60A is attached the step motor 40 which has an output rod 42 extending in parallel with the guide shaft 8. The output rod 42 has a pin 43 at an end thereof. In the meantime, though not shown, the step motor 40 has a gear mechanism so as to drive the output shaft to move axially when activated.

The intermediate portion of the vertically extending servo link 50A is pivotally supported on the end portion of the spool 36 of the shift control valve 35. The servo link 50A has an upper end portion engaged with a connecting pin 48A supported by a pin support portion 49A of the pulley follower 45A and a lower end portion engaged with a connecting pin 43 of the output rod 42 of the step motor 40.

In accordance with movement of the servo link 50A that is responsive to movement of the step motor 40, the valve spool 36 of the shift control valve 35 is moved to control supply and discharge of oil pressure to and from the primary cylinder chamber 17 and thereby control the primary pressure so that a target transmission ratio that is commanded by the drive position of the step motor 40 is attained. When the movable sheave 16b is moved to accomplish a change of speed, the shift control valve 35 is closed in response to pivotal movement of the servo link 50A in the opposite direction.

A V-belt type CVT having a structure similar to that described above is disclosed in Examined Japanese Patent Publication No. 3-72863.

### SUMMARY OF THE INVENTION

In the conventional speed-change mechanism, the servo link 50A extends vertically as described above and there are disposed from the primary pulley 16 downward, the speed-change control valve 35 and the step motor 40. Furthermore, in order to attain a predetermined lever ratio of the servo link 50A that is required from the relation between the stroke of the output rod 42 of the step motor 40 and the resulting axial movement of the spool 36, the primary pulley 16, the speed-change control valve 35 and the step motor 40 are required to be spaced from one another.

For this reason, the step motor 40 is disposed considerably lower than the primary pulley 16 and therefore the height of the belt-type CVT including an oil pan 7 in which the step motor 40 is accommodated becomes large, thus causing a problem that there is a difficulty of making the belt-type CVT smaller in size.

It is accordingly an object of the present invention to provide a step motor arrangement in a belt-type CVT which enables the belt-type CVT to be small in height and thereby to be small-sized.

According to an aspect of the present invention, there is provided, in a belt-type continuously variable transmission including a speed-change mechanism having a primary pulley on an input side, a secondary pulley on an output side and a belt wound around the primary pulley and the secondary pulley, a step motor arrangement comprising a pulley follower engaged with a movable sheave of the primary pulley, a speed-change control valve for controlling a primary pressure to be supplied to the primary pulley, a servo link, and a step motor for driving, by way of the servo link, the speed-change control valve in response to a speed-change command signal, the servo link being connected to the pulley follower to follow a variation in a width of a pulley groove of the primary pulley and thereby perform feedback control of the width of the groove of the primary pulley, wherein the servo link extends generally horizontally from the pulley follower to interconnect the pulley follower, the speed-change control valve and the step motor.

According to another aspect of the present invention, there is provided a belt-type continuously variable transmission comprising a speed-change mechanism having a primary pulley on an input side, a secondary pulley on an output side and a belt wound around the primary pulley and the secondary pulley, a pulley follower engaged with a movable sheave of the primary pulley, a speed-change control valve for controlling a primary pressure to be supplied to the primary pulley, a servo link, and a step motor for driving, by way of the servo link, the speed-change control valve in response to a speed-change command signal, the servo link being connected to the pulley follower to follow a variation in a width of a groove of the primary pulley and thereby perform feedback control of the width of the groove of the primary pulley, wherein the pulley follower, the speed-change control valve and the step motor are arranged side by side in the horizontal direction, and wherein the servo link extends generally horizontally from the pulley follower to interconnect the pulley follower, the speed-change control valve and the step motor.

### BRIEF DESCRIPTION OF THE DRAWINGS

FIG. 1 is a plan view of a step motor arrangement according to an embodiment of the present invention;

FIG. 2 is an elevational view of the step motor arrangement of FIG. 1;

FIG. 3 is a schematic view of a speed-change control section of a V-belt CVT to which the present invention is applied;

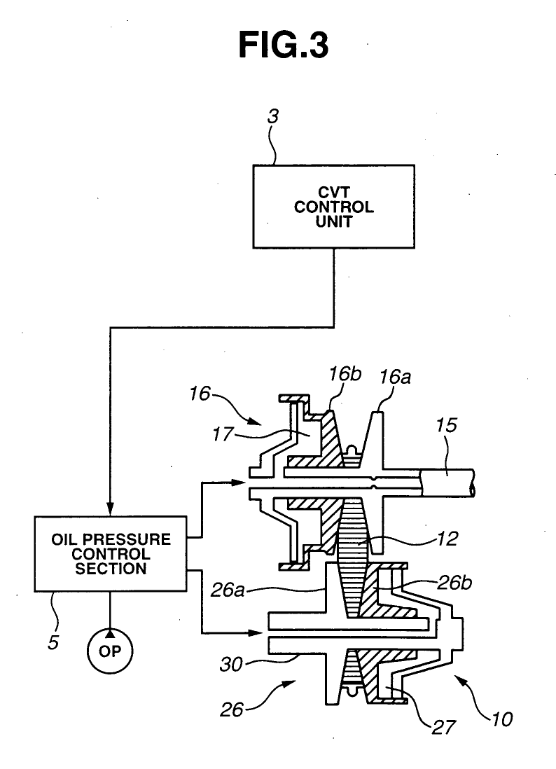

FIG. 4 is a schematic view showing a mechanical feedback device for performing feedback of a width of a pulley groove of a primary pulley;

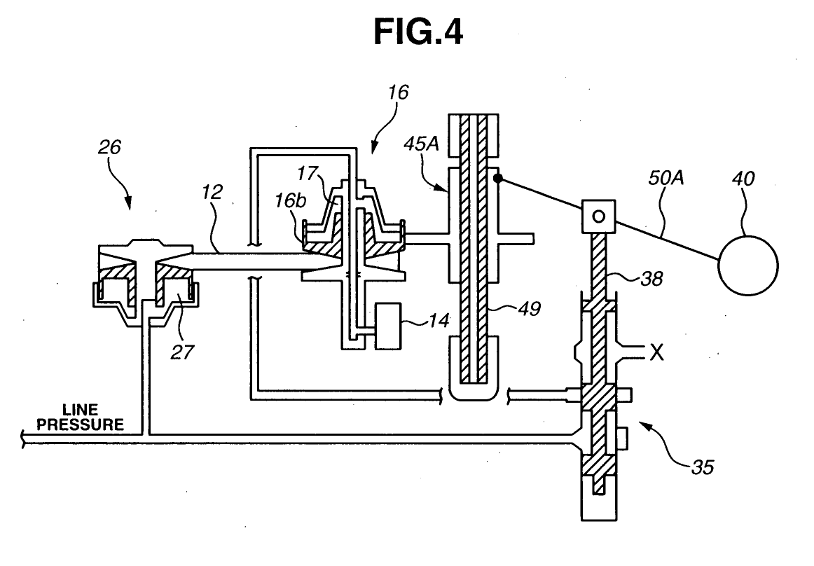

FIG. 5 is a longitudinal sectional view of a prior art step motor arrangement; and

FIG. 6 is a view of the step motor arrangement of FIG. 5, which is taken in the axial direction of the step motor.

### DESCRIPTION OF THE PREFERRED EMBODIMENT

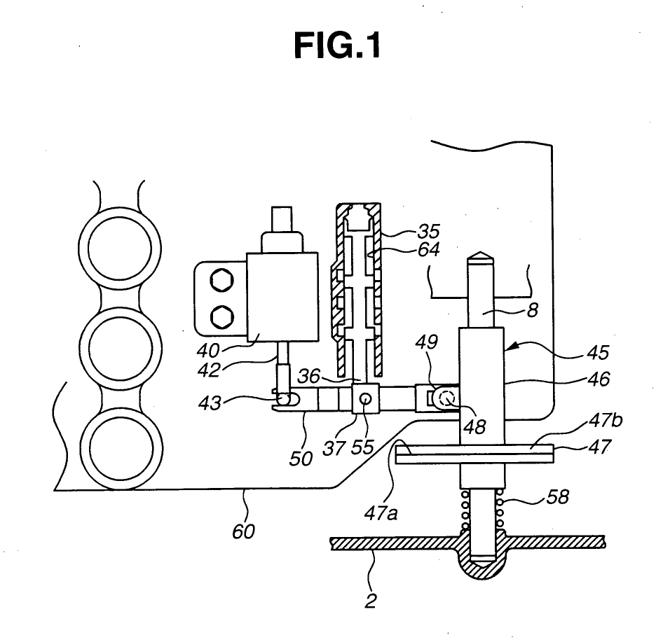

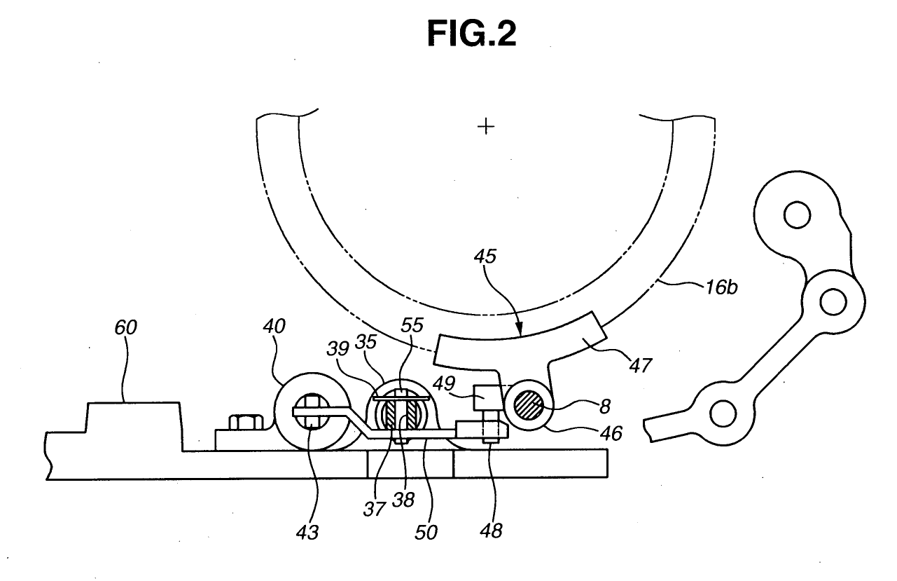

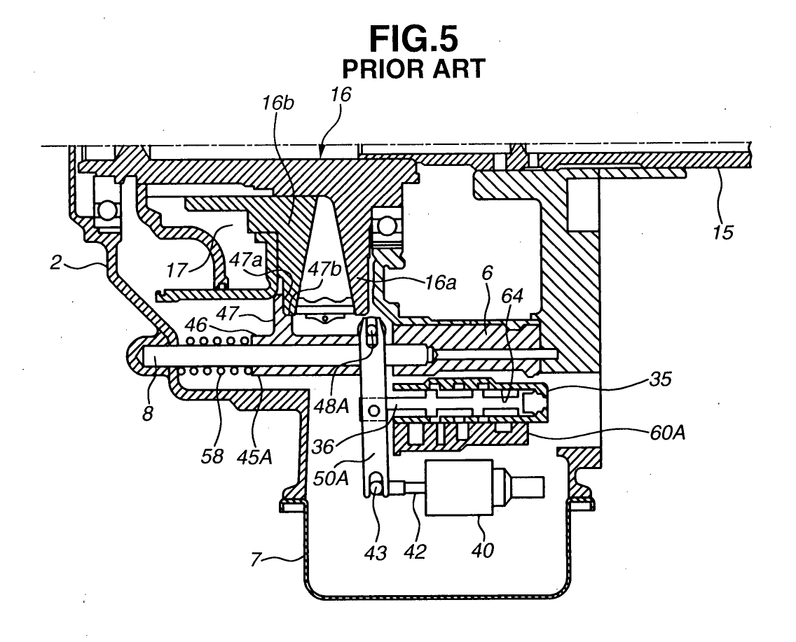

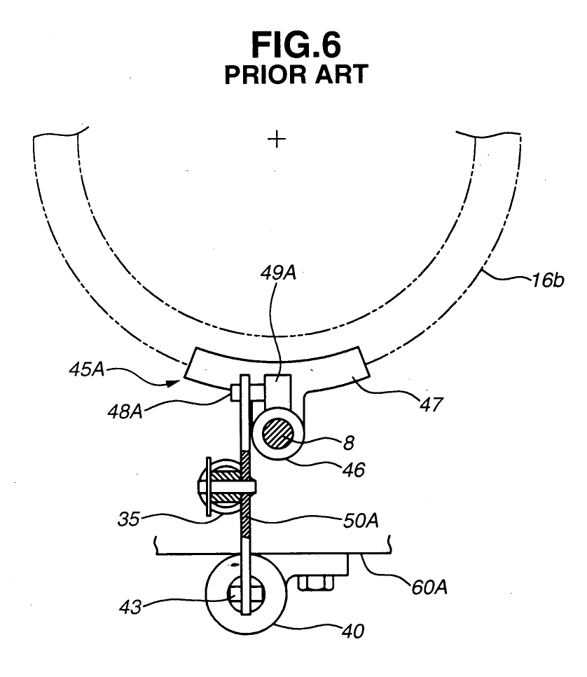

Referring first to FIGS. 1 and 2 in which like parts to those of the prior art structure of FIGS. 5 and 6 are designated by like reference characters, similarly to the prior art structure, a guide shaft 8 is disposed right under a primary pulley 16 (refer to FIG. 5) within a transmission case 2 and in parallel with an axis of rotation of the primary pulley 16, and a pulley follower 45 is slidably mounted on the guide shaft 8.

The pulley follower 45 includes a sleeve portion 46 through which the guide shaft 8 passes and an engagement portion 47 extending from the sleeve portion 46 toward the primary pulley 16 side. The engagement portion 47, when viewed in the axial direction of the guide shaft 8, in the form of a circular arc corresponding to the outer periphery of the movable sheave 16b of the primary pulley 16. The engagement portion 47 has a stepped cross section so as to have a first surface 47a for contact with the movable sheave 16b, which surface is located on the side opposite to the fixed sheave 16a side and a second surface 47b for contact with the outer circumferential periphery of the movable sheave 16b.

The pulley follower 45A is always urged against the movable sheave 16b by means of a spring 58 disposed between the transmission case 2 and the pulley follower 45A and slidably movable in accordance with a variation of the axial position of the movable sheave 16b.

The structure described above is substantially the same as the prior art structure described with reference to FIG. 5.

The sleeve portion 46 of the pulley follower 45 is provided with a pin support portion 49. Under the condition where the engagement portion 47 is in contact with the peripheral portion of the movable sheave 16b, the pin support portion 49 protrudes horizontally from the sleeve portion 46 while allowing the connecting pin 48 to extend vertically downward.

The valve body 60 is disposed on the lower side of the primary pulley 16 and provided with the speed-change control valve 35 at nearly the same height as the guide shaft 8. The speed-change control valve 35 has a valve spool 36 that slides in parallel with the guide shaft 8.

Further, to the upper surface of the valve body 60 is attached a step motor 40 so as to be positioned adjacent the speed-change control valve 35 and on the side opposite to the guide shaft 8 side and to allow the output rod 42 to be positioned at nearly the same height as the guide shaft 8 and in parallel with the same. Namely, the guide shaft 8 and the speed-change control valve 35 are arranged side by side and nearly horizontally.

The output rod 42 of the step motor 40 has a bifurcated end portion to which a vertical connecting pin 43 is connected.

The valve spool 36 of the speed-change control valve 35 has at an end portion thereof a pin support block 37 having a pin hole 38.

The servo link 50 extends generally horizontally and have an intermediate portion to which a pivot pin 55 is fixedly attached in a way as to protrude vertically upward therefrom. The pivot pin 55 extends through the pin hole 38 of the block 37 at the end of the valve spool 36 and is prevented from being slipped off therefrom by means of a clevis pin 39.

The servo link 50 have axially opposite, bifurcated end portions, one of which is engaged with the connecting pin 48 of the pulley follower 45 and the other of which is engaged with the connecting pin 43 of the output rod 42 of the step motor 40.

More specifically, the servo link 50 is vertically stepped so as to be partly disposed at nearly the same height as the output rod 42 of the step motor 40 and partly disposed lower than the guide shaft 8 and the connecting end of the valve spool 36 such that the pulley follower 45, the speed-change control valve 35 and the step motor 40 are disposed at nearly the same height.

More specifically, the servo link 50 includes a higher level portion and a lower level portion and engaged at the higher level portion with the output shaft 42 of the step motor 40 and at the lower level portion with the speed-change control valve 35 and the pulley follower 45.

More specifically, the servo link 50 has at the lower level portion thereof the bifurcated end and engaged at the bifurcated end with the connecting pin 48 extending downward from the pulley follower 47.

The other structure is substantially the same as the prior art structure.

In accordance with movement of the servo link 50 that is responsive to the step motor 40, the valve spool 36 is axially moved to cause the speed-change control valve 35 to perform supply or discharge of oil pressure to or from the primary cylinder chamber 17 and thereby control the primary pressure so that a target transmission ratio commanded by the driving position of the step motor 40 is attained. When the movable sheave 16b is moved to attain a speed-change, the speed-change control valve 35 is closed in response to pivotal movement of the servo link 50 in the opposite direction.

In the embodiment of the present invention, the step motor 40 is arranged laterally of the pulley follower 45 that is engaged with the movable sheave 16b of the primary pulley 16, together with the speed-change control valve 35 such that the step motor 40 and the speed-change control valve 35 are arranged at nearly the same height or level as the pulley follower 45. As a result, the servo link 50 extends horizontally from the pulley follower 45 to interconnect the pulley follower 45, the speed-change control valve 35 and the step motor 40.

Accordingly, the space for accommodating therewithin the step motor that is disposed right under the primary pulley as in the prior art structure can be dispensed with, thus considerably decreasing the height of the belt-type CVT including the oil pan. By this, the belt-type CVT can be small-sized in its entirety.

The entire contents of Japanese Patent Applications P2004-056354 (filed Mar. 1, 2004) are incorporated herein by reference.

Although the invention has been described above by reference to a certain embodiment of the invention, the invention is not limited to the embodiment described above. Modifications and variations of the embodiment described above will occur to those skilled in the art, in light of the above teachings. The scope of the invention is defined with reference to the following claims.

1. In a belt-type continuously variable transmission including a speed-change mechanism having a primary pulley on an input side, a secondary pulley on an output side and a belt wound around the primary pulley and the secondary pulley, a step motor arrangement comprising:
a pulley follower engaged with a movable sheave of the primary pulley;
a speed-change control valve for controlling a primary pressure to be supplied to the primary pulley;
a servo link; and
a step motor for driving, by way of the servo link, the speed-change control valve in response to a speed-change command signal;
the servo link being connected to the pulley follower to follow a variation in a width of a groove of the primary pulley and thereby perform feedback control of the width of the groove of the primary pulley;
wherein the pulley follower, the speed-change control valve and the step motor are arranged side by side in the horizontal direction; and
wherein the servo link extends generally horizontally from the pulley follower to interconnect the pulley follower, the speed-change control valve and the step motor.

2. A step motor arrangement according to claim 1, wherein the pulley follower is movable on a guide shaft, the speed-change control valve has a valve spool with a connecting end portion and the step motor has an axially movable output shaft, and wherein the servo link is vertically stepped so as to be partly disposed substantially at the same height as the output rod of the step motor and partly lower than the guide shaft and the connecting end of the valve spool such that the pulley follower, the speed-change control valve and the step motor are disposed at nearly the same height.

3. A step motor arrangement according to claim 2, wherein the servo link comprises a higher level portion and a lower level portion and engaged at the higher level portion with the output shaft of the step motor and at the lower level portion with the speed-change control valve and the pulley follower.

4. A step motor arrangement according to claim 3, wherein the servo link has at the lower level portion thereof a bifurcated end and engaged at the bifurcated end with a connecting pin extending downward from the pulley follower.

5. A step motor arrangement according to claim 4, wherein the pulley follower comprises a sleeve portion at which it is slidably mounted on the guide shaft and an engagement portion at which it is engaged with the movable sheave of the primary pulley, and wherein the sleeve portion includes a pin support portion which protrudes horizontally therefrom and to which the connecting pin is attached.

6. A step motor arrangement according to claim 5, wherein the servo link has at the higher level portion thereof a bifurcated end and engaged at the bifurcated end with a connecting pin provided to a bifurcated end of the output rod of the step motor.

7. A step motor arrangement according to claim 6, wherein the servo link has at an intermediate portion constituting part of the lower level portion a pivot pin extending upward therefrom and engaged at the pivot pin with an end of the valve spool of the speed-change control valve.

8. A step motor arrangement according to claim 2, wherein the servo link extends transversely of the guide rod.

9. A step motor arrangement according to claim 2, wherein the guide shaft is disposed parallel with the valve spool of the speed-change control valve and the output shaft of the step motor.

10. A step motor arrangement according to claim 1, wherein the speed-change control valve is disposed between the pulley follower and the step motor.

11. A belt-type continuously variable transmission comprising:
a speed-change mechanism having a primary pulley on an input side, a secondary pulley on an output side and a belt wound around the primary pulley and the secondary pulley;
a pulley follower engaged with a movable sheave of the primary pulley;
a speed-change control valve for controlling a primary pressure to be supplied to the primary pulley;
a servo link; and
a step motor for driving, by way of the servo link, the speed-change control valve in response to a speed-change command signal;
the servo link being connected to the pulley follower to follow a variation in a width of a groove of the primary pulley and thereby perform feedback control of the width of the groove of the primary pulley;
wherein the pulley follower, the speed-change control valve and the step motor are arranged side by side in the horizontal direction; and
wherein the servo link extends generally horizontally from the pulley follower to interconnect the pulley follower, the speed-change control valve and the step motor.

12. A belt-type continuously variable transmission according to claim 11, wherein the pulley follower is movable on a guide shaft, the speed-change control valve has a valve spool with a connecting end portion and the step motor has an axially movable output shaft, and wherein the servo link is vertically stepped so as to be partly disposed substantially at the same height as the output rod of the step motor and partly lower than the guide shaft and the connecting end of the valve spool such that the pulley follower, the speed-change control valve and the step motor are disposed at nearly the same height.

13. A belt-type continuously variable transmission according to claim 12, wherein the servo link comprises a higher level portion and a lower level portion and engaged at the higher level portion with the output shaft of the step motor and at the lower level portion with the speed-change control valve and the pulley follower.

14. A belt-type continuously variable transmission according to claim 13, wherein the servo link has at the lower level portion thereof a bifurcated end and engaged at the bifurcated end with a connecting pin extending downward from the pulley follower.

15. A belt-type continuously variable transmission according to claim 14, wherein the pulley follower comprises a sleeve portion at which it is slidably mounted on the guide shaft and an engagement portion at which it is engaged with the movable sheave of the primary pulley, and wherein the sleeve portion includes a pin support portion which protrudes horizontally therefrom and to which the connecting pin is attached.

16. A belt-type continuously variable transmission according to claim 15, wherein the servo link has at the higher level portion thereof a bifurcated end and engaged at the bifurcated end with a connecting pin provided to a bifurcated end of the output rod of the step motor.

17. A belt-type continuously variable transmission according to claim 16, wherein the servo link has at an intermediate portion constituting part of the lower level portion a pivot pin extending upward therefrom and engaged at the pivot pin with an end of the valve spool of the speed-change control valve.

18. A belt-type continuously variable transmission according to claim 13, wherein the servo link extends transversely of the guide rod.

19. A belt-type continuously variable transmission according to claim 12, wherein the guide shaft is disposed parallel with the valve spool of the speed-change control valve and the output shaft of the step motor.

20. A belt-type continuously variable transmission according to claim 11, wherein the speed-change control valve is disposed between the pulley follower and the step motor.
